(19) United States
(12) Patent Application Publication
(10) Pub. No.: US 2026/0201072 A1
(43) Pub. Date: Jul. 16, 2026

(54) BIOMASS TREATMENT

(71) Applicant: Bio-Sep Limited, Southampton, Hampshire (GB)

(72) Inventors: Ken DAY, Southampton (GB); Andrew WEST, Southampton (GB)

(73) Assignee: Bio-Sep Limited, Southampton, Hampshire (GB)

(21) Appl. No.: 19/138,786

(22) PCT Filed: Dec. 12, 2023
(86) PCT No.: PCT/GB2023/053202

§ 371 Date: Jun. 13, 2025

(30) Foreign Application Priority Data
Dec. 13, 2022 (GB) 2218784.3

(51) Int. Cl. C08B 1/00; C08H 7/00

(52) U.S. Cl. CPC C08B 1/003; C08H 6/00

(57) ABSTRACT

According to a first aspect, there is provided a method of fractionating a biomass material. The method comprises treating the biomass material with an aqueous medium to form a slurry. The method further comprises subjecting the slurry to sonication to produce a sonicated mixture comprising a liquid component (L) and a solid component (S) comprising lignin and cellulose. The aqueous medium can comprise an acid (preferably organic acid) catalyst.

### FIELD OF THE INVENTION

The present invention relates to the technical field of biomass treatment. The invention has a particular, but not exclusive, application to the treatment of biomass materials and provides a method of fractionating biomass material. The invention also relates to a composite material. The invention further relates to a method of preparing lignin.

### BACKGROUND

Most biomass materials, such as wood, are referred to as lignocellulosic material and comprise three main components, namely, cellulose, hemi-cellulose and lignin. It may be desirable to separate biomass materials in order to obtain economically competitive natural biochemicals whilst at the same time delivering social, economic and environmental benefits to the planet. Lignin is considered a desirable source of base chemicals as a substitute for petrochemicals. It is desirable that any process for the separation of lignin from biomass material has the minimal environment impact and therefore uses “green technology” and is low in energy consumption and waste products. It is also the case cellulose and hemi-cellulose are valuable raw materials which is particularly the case if they can be extracted efficiently from lignocellulosic materials in an energy efficient and environmentally friendly method.

Various methods of fractionating biomass material into its major constituents are known. One process for fractionating biomass material is described in commonly-owned U.S. Pat. No. 10,000,891B2. The process of U.S. Pat. No. 10,000,891B2 comprises blending biomass material with an acid catalyst and organosolv reagent, subjecting to ultrasonic waves and separating the biomass into lignin, cellulose and hemicellulose hydrolysate. The organosolv reagent comprises MIBK, ethanol and water. The acid catalyses the hydrolysis of components of the biomass material into hemicellulose hydrolysate e.g. sugars, while the organosolv reagent facilitates extraction of lignin and hemicellulose hydrolysate into a liquid phase. Cellulose, which is insoluble in the components of the organosolv reagent, remains as solid biomass residue. In U.S. Pat. No. 10,000,891 B2, organosolv weight ratios of MIBK:ethanol:water are controlled at 44:32:24 to maintain a single, miscible liquid phase. This optimises the efficacy of sonication, while allowing lignin and hemicellulose hydrolysate to be extracted into the liquid phase. Lignin and hemicellulose hydrolysate can be subsequently separated from the liquid phase of the sonicated slurry by downstream phase separation and evaporation techniques.

### SUMMARY

According to a first aspect, there is provided a method of fractionating a biomass material. The method comprises treating the biomass material with an aqueous medium to form a slurry. The method further comprises subjecting the slurry to sonication to produce a sonicated mixture comprising a liquid component (L) and a solid component (S) comprising lignin and cellulose. The aqueous medium can comprise an acid (preferably organic acid) catalyst.

When the aqueous medium comprises ethanol and methyl isobutyl ketone (MIBK), the combined weight amount of ethanol and MIBK in the aqueous medium may be less than 40 wt. %.

The ratio of the weight of the lignin in the solid component (S) to the weight of the lignin in the liquid component (L) may be greater than 1:1, preferably greater than 2:1, more preferably greater than 4:1, even more preferably greater than 5:1, yet more preferably greater than 6:1, for example, greater than 8:1. The solid component (S) may comprise at least 50 wt. % of lignin available from the biomass material.

The method may further comprise treating the solid component (S) to separate lignin from the solid component (S). The lignin may be separated from the solid component (S) by a process comprising solvent extraction.

The lignin may be separated from the solid component (S) by sonicating the solid component (S) in a liquid medium comprising alcohol, preferably methanol, and water to produce a further sonicated mixture comprising a liquid component comprising dissolved lignin and a solid component comprising cellulose, and extracting lignin from the liquid component of the further sonicated mixture.

According to a further aspect, there is provided a method of fractionating a biomass material. The method comprises sonicating a solid component (S) comprising lignin and cellulose in a liquid medium comprising alcohol and at least 40 weight % water to produce a sonicated mixture comprising a liquid component comprising dissolved lignin and a solid component comprising cellulose, and separating lignin from the liquid component of the sonicated mixture by solvent extraction using an organic solvent.

### BRIEF DESCRIPTION OF THE FIGURES

Embodiments of the invention are further described hereinafter with reference to the accompanying drawings, in which:

FIG. 1 is a flowchart of an example of a modified process for fractionating biomass, according to the first aspect.

FIG. 2 is a flowchart of an example of a modified process for preparing lignin, according to the third aspect.

### DETAILED DESCRIPTION

The term “biomass material”, as used herein, denotes various kinds of biomass materials such as softwoods, hardwoods, grasses, straws or crop residues (including oat husks and corn stover, palm fronds and nut shells) or a mixture thereof. The terms “biomass material” and “lignocellulosic material” may be used interchangeably herein.

The term “aliphatic”, as used herein, means a substituted or unsubstituted straight-chain, branched or cyclic hydrocarbon, which is completely saturated or which contains one or more units of unsaturation, but which is not aromatic. As used herein, the term “alkyl group” refers to both branched and straight chain, saturated aliphatic hydrocarbon radicals/groups.

As used herein, if the term “substantially” is associated with a word qualifying any given means, then the qualifying word should be understood as covering both its strict meaning and an approximate meaning. For example, the term “substantially” is intended to modify a quality such that a given feature need not be “exactly” in accordance with that quality.

As used herein, ratios may be defined as ranges of ratios, such as component A to component B being in a ratio of about 1:1 to 5. This should be understood to mean that component B may be present in a range from an equal amount of component A to five times the amount of component A.

According to a first aspect, there is provided a method of fractionating a biomass material. The method comprises treating the biomass material with an aqueous medium to form a slurry. The aqueous medium can comprise an acid (preferably organic acid) catalyst. The method further comprises subjecting the slurry to sonication to produce a sonicated mixture comprising a liquid component (L) and a solid component (S) comprising lignin and cellulose.

In some embodiments, when the aqueous medium comprises ethanol and methyl isobutyl ketone (MIBK), the combined weight amount of ethanol and MIBK in the aqueous medium is less than 40 wt. %.

The solid component (S) may comprise at least 50 wt. % of lignin available from the biomass material.

The weight ratio of the amount of lignin in the solid component (S) to the amount of lignin in the liquid component (L) may be greater than about 1:1, preferably greater than about 2:1, more preferably greater than 4:1, even more preferably greater than 5:1, yet more preferably greater than 6:1, for example, greater than 7:1. In some embodiments, the ratio is greater than 10:1, greater than 20:1, greater than 30:1, greater than 50:1.

When the biomass material is sonicated in the aqueous medium, components of the biomass material can be hydrolysed into soluble components. In preferred embodiments, the aqueous medium comprises an acid (preferably organic acid) catalyst. For example, the acidic proton (H⁺) of the acid can act as a catalyst for the hydrolysis of e.g. hemicellulose polymers in the biomass material. Sonication can also increase the rate of hydrolysis, as ultrasonic waves can help to break insoluble components in the biomass material into smaller particles, increasing the surface area for reaction. It has surprisingly been found that, although organosolv reagents that typically include MIBK in combination with ethanol can be used to extract lignin from the biomass material, organosolv reagents can decrease the efficacy of sonication. This can result in hydrolysis occurring less effectively. This, in turn, can reduce the effectiveness of the separation of soluble components e.g. sugars from the biomass material.

In the present disclosure, sonication of the biomass material can be carried out either in the absence of MIBK or, where MIBK is present, the weight of MIBK is less than 10 wt. % of the aqueous medium. By excluding or limiting the amount of MIBK, it may be possible for cavitation to occur more effectively during sonication. This allows hydrolysis of components of the biomass material to occur more effectively. This, in turn, can result in improved separation of soluble components e.g. sugars and other hemicellulose hydrolysates from the biomass material.

In some embodiments, sonication of the biomass material can be carried out either in the absence of MIBK and ethanol or, where ethanol and MIBK is present, the combined weight of MIBK and ethanol is less than 40 wt. % of the aqueous medium. By excluding or limiting the amount of ethanol and MIBK, it may be possible for cavitation to occur more effectively during sonication. This allows hydrolysis of components of the biomass material to occur more effectively. This, in turn, can result in improved separation of soluble components e.g. sugars and other hemicellulose hydrolysates from the biomass material.

In the first aspect of the present disclosure, lignin in the biomass material can be recovered from the solid component of the slurry. This contrasts with, for example, U.S. Pat. No. 10,000,891 B2. In U.S. Pat. No. 10,000,891 B2, an organosolv reagent is included in the sonicated slurry, such that lignin extraction and hydrolysis takes place in a one-pot mixture to extract lignin, and sugars and other hemicellulose hydrolysates in a liquid phase. In the present disclosure, on the other hand, lignin can be recovered from the solid components of the slurry downstream of the sonication step. As will be explained below, this can allow for greater flexibility on the choice of solvent for lignin recovery, as the selected solvents no longer need to provide a medium for hydrolysis and/or sonication. Moreover, since ethanol and MIBK are excluded or limited in the sonicated slurry, sonication can be improved. This can result in the formation of e.g. smaller lignin particles during sonication, which can facilitate improved solvent extraction of lignin downstream. Furthermore, it has been advantageously found that recovering lignin from the solid component can improve the purity of lignin separated from biomass material. That is, by removing the hydrolysed components of the biomass material beforehand, there are fewer contaminants extracted with the lignin during separation, as will be explained below.

As mentioned above, the biomass material is treated with the aqueous medium. Specifically, the biomass material is dispersed in the aqueous medium to form a slurry. When the slurry is initially formed, for example, before sonication, the biomass content of the slurry may be 3 to 50 weight %, preferably 5 to 30 weight %, more preferably 10 to 20 or 10 to 15 weight %. Preferably, the aqueous medium comprises an acid catalyst to hydrolyse components of the biomass into soluble components. Preferably, the acid is an organic acid. The acid provides a source of protons for catalysing the hydrolysis of components of the biomass material. For example, the acid may catalyse hydrolysis of cellulose to glucose or the hydrolysis of hemicellulose to hemicellulose hydrolysates (e.g. sugars).

The aqueous medium may comprise any suitable acid catalyst with varying strengths of acidity. For example, the acid may comprise an organic acid, such as an aliphatic carboxylic acid, an aliphatic dicarboxylic acid, an aminocarboxylic acid or an aminodicarboxylic acid. In a preferred embodiment, the acid catalyst is an organic acid with a pH of below 4, preferably below 3.9 at 1 mM concentrations. In some examples, the concentration of acid catalyst present in the aqueous medium is about 1 M or less e.g. about 0.005 M to about 1 M, preferably about 0.01 M to about 0.5 M or about 0.05 M to about 0.3 M, more preferably about 0.1 M to about 0.2 M. In some embodiments, the concentration of the acid catalyst present in the aqueous medium is about 0.1 M or about 0.2 M. In a preferred embodiment, the acid catalyst is oxalic acid catalyst present at a concentration of about 1 M or less e.g. about 0.005 M to about 1 M, preferably about 0.01 M to about 0.5 M or about 0.05 M to about 0.3 M, more preferably about 0.1 M to about 0.2 M. In some embodiments, the concentration of the oxalic acid catalyst present in the aqueous medium is about 0.1 M or about 0.2 M. The acid catalyst may generally have a pKa of less than 5, e.g. from 2 to 5. In the case of a dicarboxylic acid, and especially a dicarboxylic amino acid where the carboxylic acid moieties within the molecule may have different pKa values, at least one of the carboxylic acid moieties should desirably have a pKa of less than 5. Thus, for example, an aliphatic carboxylic acid or an aliphatic dicarboxylic acid may contain 1 to 6 carbon atoms in the molecule, preferably 1 to 4 carbon atoms. Examples of organic carboxylic acids include, but shall not be limited to, acetic acid and formic acid. Such acids are recognised as being weak acids. In some examples, the acid catalyst may be selected from the group consisting of oxalic acid, citric acid, maleic acid, acetic acid, lactic acid, formic acid, ascorbic acid or a mixture thereof. Alternatively, the acid may be a dicarboxylic acid. In a preferred embodiment, the acid catalyst is oxalic acid.

Sonication with ultrasound is beneficial in the hydrolysis of biomass material to hemicellulose hydrolysate and glucose. The hemicellulose hydrolysate may comprise, for example, dissolved sugars e.g. monosaccharides such as mannitol, fucose, rhamnose, arabinose, galactose, glucose, xylose, fructose, ribose, galacturonic acid, guluronic acid, glucuronic acid, mannuronic acid and iduronic acid. In some examples, monomeric sugars/monosaccharides are formed. Such monosaccharides are beneficial in their own right or in the generation of fermentation products, etc. Dimer and trimer sugars may also be formed from the hydrolysis of hemicellulose. In some examples, cellulose available from the biomass material is hydrolysed to glucose. In a preferred embodiment, the hemicellulose hydrolysate and glucose are extracted in the liquid component (L). IThe solid component (S) may be separated from the liquid component (L). Suitable separation methods include filtration. The separated liquid component (L) may comprise the hemicellulose hydrosylate (e.g. dissolved sugars) and water, as well as any acid that may have been present in the ultrasonication step. The hemicellulose hydrosylate mat be separated from any acid present by any suitable method. An example is nanofiltration.

In the first aspect of the present disclosure, the slurry of biomass is sonicated to produce a sonicated mixture comprising a liquid component (L) and a solid component (S) comprising lignin and cellulose, wherein the ratio of the weight of the lignin in the solid component (S) to the weight of the lignin in the liquid component (L) is greater than 2:1. As explained above, while sonication extracts hemicellulose hydroxylates into the liquid component (L), the majority of the lignin remains in the solid phase following sonication. This may be achieved by limiting the amount of e.g., organic solvents in the aqueous medium. For example, the amount of water in the aqueous medium may be at least 80 weight %, preferably, at least 85 weight %, more preferably at least 90 weight %. It may also be desirable to limit the amount of ketone, specifically MIBK, in the aqueous medium as discussed above. For example, the amount of MIBK in the aqueous medium, if present, may be less than 10 weight %. By tailoring the nature of the aqueous medium and the sonication conditions (see below), it is possible to achieve desirable hydrolysis and extraction of hemicellulose hydrolysates into the liquid component (L), while maintaining the bulk of lignin in the solid component (S). This allows lignin extraction to be carried out after the solid component (S) is separated from the liquid component (L) so that the extracted hemicellulose hydrosylate need not come into contact with any organic solvents that may be used for lignin extraction downstream.

In a preferred embodiment, the aqueous medium comprises acid catalyst and water in a combined weight amount of at least 90%. Preferably, the aqueous medium comprises acid catalyst and water in a combined weight amount of at least 95%, optionally at least 97%, optionally at least 99%, optionally at least 99.5%. In a preferred embodiment, the aqueous medium may consist essentially of water and acid catalyst.

In one embodiment, the aqueous medium does not comprise ethanol and/or MIBK. However, if the aqueous medium comprises ethanol and MIBK, the combined weight amount of ethanol and MIBK in the aqueous medium is less than 40%. Preferably, the combined weight amount of ethanol and MIBK in the aqueous medium is less than 40%, optionally less than 30%, optionally less than 20%, optionally less than 10%, optionally less than 5%, optionally less than 3%, optionally less than 2%, optionally less than 1%, optionally less than 0.5% or optionally less than 0.05%. Preferably, when the aqueous medium comprises ethanol and MIBK, then the weight amount of ethanol is less than 30% and the weight amount of MIBK is less than 10%.

In a preferred embodiment, the aqueous medium does not comprise ketone. However, if ketone is present, the ketone may be methyl ethyl ketone (MEK), methyl isopropyl ketone, methyl propyl ketone, methyl butyl ketone, methyl isobutyl ketone (MIBK), methyl isoamylketone, diethyl ketone, dimethyl ketone (acetone), diacetone alcohol (DAA), diisobutylketone (DIBK), ethyl isopropyl ketone, ethyl propyl ketone, and ethyl isobutyl ketone, or a mixture thereof. In an embodiment, when the aqueous medium comprises ketone, the weight amount of ketone present may be less than 10%, optionally less than 5%, optionally 4%, optionally less than 3%, optionally less than 2%, optionally less than 1%, optionally less than 0.05%. In a preferred embodiment, the aqueous medium does not comprise MIBK. When the aqueous medium comprises MIBK, the weight amount of MIBK present may be less than 10%, optionally less than 5%, optionally 4% of MIBK, optionally less than 3%, optionally less than 2%, optionally less than 1%, optionally less than 0.05%.

In an embodiment, the aqueous medium does not comprise alcohol. However, if alcohol is present, the alcohol may be a primary, secondary or tertiary alcohol. In some examples, the alcohol may have a boiling point of less than 125° C. In some examples, the alcohol may have less than about 4 carbon atoms. For example, the alcohol may be selected from the group consisting of methanol, ethanol, propanol, isopropanol, butanol, butan-2-ol, t-butanol, or mixtures thereof. In some examples, the aqueous medium does not comprise methanol, ethanol, propanol, isopropanol, butanol, butan-2-ol, t-butanol, or mixtures thereof. In an embodiment, when the aqueous medium comprises the alcohol, the weight amount of the alcohol present may be less than 50%, for example, less than 30%, optionally less than 25%, optionally less than 20%, optionally less than 15%, optionally less than 10%, optionally less than 5%, optionally less than 3%, optionally less than 1%, optionally less than 0.05%. In an embodiment, the aqueous medium does not comprise ethanol. However, when the aqueous medium comprises ethanol, the weight amount of ethanol present is less than 30%, optionally less than 25%, optionally less than 20%, optionally less than 15%, optionally less than 10%, optionally less than 5%, optionally less than 3%, optionally less than 1%, optionally less than 0.05%.

In a preferred embodiment, the aqueous medium does not comprise alcohol and ketone. However, if the aqueous medium comprises alcohol and ketone, the combined weight amount of alcohol and ketone in the aqueous medium is less than 40%. Preferably, the combined weight amount of alcohol and ketone in the aqueous medium is less than 40%, optionally less than 30%, optionally less than 20%, optionally less than 10%, optionally less than 5%, optionally less than 3%, optionally less than 2%, optionally less than 1%, optionally less than 0.5% or optionally less than 0.05%. Preferably, when the aqueous medium comprises alcohol and ketone, then the weight amount of alcohol is less than 30% and the weight amount of ketone is less than 10%.

In oneembodiment, the aqueous medium does not comprise organic solvent. However, if organic solvent is present, the aqueous medium may comprise less than 40 wt. % of organic solvent. The weight amount of organic solvent in the aqueous medium may be less than 40%, optionally less than 30%, optionally less than 20%, optionally less than 10%, optionally less than 5%, optionally less than 3%, optionally less than 2%, optionally less than 1%, optionally less than 0.5% or optionally less than 0.05%.

When the biomass material is treated with the aqueous medium a slurry is formed. By “slurry”, it is meant that the particulate biomass material may be suspended in the aqueous medium, e.g. upon agitation. The slurry is preferably devoid of ethanol and MIBK. However, if the slurry comprises ethanol and MIBK, the combined weight amount of ethanol and MIBK in the liquid portion of the slurry is less than 40%. Preferably, the combined weight amount of ethanol and MIBK in the liquid portion of the slurry is less than 30%, optionally less than 20%, optionally less than 10%, optionally less than 5%, optionally less than 3%, optionally less than 2%, optionally less than 1%, optionally less than 0.5% or optionally less than 0.05%.

In a preferred embodiment, the slurry does not comprise ketone. However, if the slurry includes ketone, the ketone may be methyl ethyl ketone (MEK), methyl isopropyl ketone, methyl propyl ketone, methyl butyl ketone, methyl isobutyl ketone (MIBK), methyl isoamylketone, diethyl ketone, dimethyl ketone (acetone), diacetone alcohol (DAA), diisobutylketone (DIBK), ethyl isopropyl ketone, ethyl propyl ketone, and ethyl isobutyl ketone, or a mixture thereof. In an embodiment, when the slurry comprises ketone, the weight amount of ketone present in the liquid portion of the slurry may be less than 10%, optionally less than 5%, optionally 4% of MIBK, optionally less than 3%, optionally less than 2%, optionally less than 1%, optionally less than 0.05%. The slurry is preferably free from MIBK. However, if the slurry comprises MIBK, the weight amount of MIBK present in the liquid portion of the slurry may be less than 10%, optionally less than 5%, optionally 4% of MIBK, optionally less than 3%, optionally less than 2%, optionally less than 1%, optionally less than 0.05%.

In an embodiment, the slurry does not comprise an alcohol. However, if the slurry comprises alcohol, the alcohol may be a primary, secondary or tertiary alcohol. In some examples, the alcohol has a boiling point of less than 125° C. In some examples, the alcohol may have less than about 4 carbon atoms. For example, the alcohol may be selected from the group consisting of methanol, ethanol, propanol, isopropanol, butanol, butan-2-ol, t-butanol, or mixtures thereof. In a preferred embodiment, the alcohol is ethanol. In an embodiment, when the slurry comprises the alcohol, the weight amount of the alcohol present in the liquid portion of the slurry is less than 50%, optionally less than 40%, optionally less than 30%, optionally less than 25%, optionally less than 20%, optionally less than 15%, optionally less than 10%, optionally less than 5%, optionally less than 3%, optionally less than 1%, optionally less than 0.05%. The slurry is preferably free from ethanol. This is because ethanol forms an azeotrope with water and may be more difficult to separate in downstream steps, for example, by distillation. However, if the slurry comprises ethanol, the weight amount of ethanol present in the liquid portion of the slurry is less than 30%, optionally less than 25%, optionally less than 20%, optionally less than 15%, optionally less than 10%, optionally less than 5%, optionally less than 3%, optionally less than 1%, optionally less than 0.05%.

In a preferred embodiment, the slurry does not comprise alcohol and ketone. However, if the slurry comprises alcohol and ketone, the combined weight amount of alcohol and ketone present in the liquid portion of the slurry is less than 40%. Preferably, the combined weight amount of alcohol and ketone present in the liquid portion of the slurry is less than 40%, optionally less than 30%, optionally less than 20%, optionally less than 10%, optionally less than 5%, optionally less than 3%, optionally less than 2%, optionally less than 1%, optionally less than 0.5% or optionally less than 0.05%. Preferably, when the slurry comprises alcohol and ketone, then the weight amount of alcohol present in the liquid portion of the slurry is less than 30% and the weight amount of ketone present in the liquid portion of the slurry is less than 10%.

In a preferred embodiment, the slurry does not comprise organic solvent. However, if the slurry comprises organic solvent, the liquid portion of the slurry comprises less than 40 wt. % of organic solvent. Preferably, the weight amount of organic solvent present in the liquid portion of the slurry is less than 40%, optionally less than 30%, optionally less than 20%, optionally less than 10%, optionally less than 5%, optionally less than 3%, optionally less than 2%, optionally less than 1%, optionally less than 0.5% or optionally less than 0.05%.

As mentioned above, after sonication, the resulting slurry comprises a solid component (S) and a liquid component (L). The solid component (S) may comprise lignin and cellulose. This solid component (S) may be used to form a composite material, as will be described below. Alternatively, the solid component (S) may be treated to separate lignin and cellulose from the solid component (S).

In some embodiments, the method may further comprise separating the liquid component (L) and the solid component (S) of the sonicated mixture. The liquid component (L) and the solid component (S) may be present in a weight ratio of about 5 to 20:1, preferably about 10 to 15:1.

The lignin in the solid component (S) may be residual lignin available from the biomass material. In some examples, the solid component (S) comprises at least 50 wt. % of lignin available from the biomass material. In one embodiment, the solid component (S) comprises at least 60 wt. % of lignin available from the biomass material, optionally at least 70 wt. %, optionally at least 80 wt. %, optionally at least 85 wt. %. In a preferred embodiment, the solid component (S) comprises at least 90 wt. % of lignin available from the biomass material. For example, in some embodiments, up to 100 wt % of the lignin available from the biomass material remains as a solid component (S) in the slurry following sonication. As noted above, this contrasts with U.S. Pat. No. 10,000,891 B2, which seeks to extract the lignin from the biomass material as a liquid extract.

Preferably, substantially no lignin available from the biomass material is extracted in liquid component (L). However, some soluble lignin (e.g. acid-soluble lignin) may be extracted into the liquid component (L). In some embodiments, the liquid component (L) may comprise less than 50 wt. % of lignin available from the biomass material. In one embodiment, the liquid component (L) comprises less than 40 wt. % of lignin available from the biomass material, optionally less than 30 wt. %, optionally less than 20 wt. %, optionally less than 15 wt. %. In a preferred embodiment, the liquid component (L) comprises less than 10 wt. % of lignin available from the biomass material. For example, as mentioned above, in some embodiments, up to 100 wt % of the lignin available from the biomass material remains as a solid component (S) in the slurry following sonication.

The ratio of the amount of lignin in the solid component (S) and liquid component (L) is greater than about 1:1, preferably greater than about 2:1, more preferably greater than 4:1, even more preferably greater than 5:1, yet more preferably greater than 6:1, for example, greater than 7:1. In some embodiments, the ratio is greater than 9:1, greater than 10:1, greater than 20:1, greater than 40:1.

The method may further comprise separating lignin, cellulose and/or hemicellulose hydrolysate from the sonicated mixture. The method may further comprise separating the solid component (S) and the liquid component (L) of the sonicated mixture. In a preferred embodiment, the solid component (S) is separated by filtration. The solid component (S) may then be washed and dried. The method may further comprise separating the lignin and/or cellulose from the solid component (S).

In some examples, the liquid component (L) comprises hemicellulose hydrolysate and/or glucose. The method may further comprise separating the hemicellulose hydrolysate from the liquid component (L). The hemicellulose hydrolysate, such as dissolved sugars e.g. monosaccharides are obtained from the sonication and hydrolysis of hemi-cellulose and cellulose. For example, the sugars e.g. mannitol, fucose, rhamnose, arabinose, galactose, glucose, xylose, fructose, ribose, galacturonic acid, guluronic acid, glucuronic acid, mannuronic acid and iduronic acid, or mixtures thereof may be present in the liquid component (L). When the aqueous medium comprises an acid catalyst, the liquid component (L) may also comprise the acid catalyst. As mentioned above, the hemicellulose hydrosylate can be separated from any acid present in the liquid component by, for example, nanofiltration.

The method of the first aspect herein distinguishes from conventional methods as it is not necessary to solubilise lignin and sonicate the biomass material in a single step. It has been surprisingly found that, by separating the lignin extraction and sonication steps, the solvent system used to separate lignin does not need to be tailored to or bound by the conventional single phase used during sonication. Thus, this can allow for greater flexibility on the choice of solvent for lignin separation and solvents not typically selected during sonication, e.g. methanol, can be used for effective lignin separation.

It has also been found that sonication of the slurry causes insoluble particles to be broken down more effectively. For example, the lignin present in the solid component (S′) may be broken down into smaller particle sizes. For example, the lignin separated may have relatively lower average molecular weights, such as less than about 3000 g/mol e.g. less than about 2000 g/mol or less than about 1500 g/mol. In some examples, the lignin may have an average molecular weight of between about 500 g/mol to about 3000 g/mol e.g. between 500 g/mol to about 1500 g/mol.

Advantageously, a significantly lesser amount of solvent may be required to extract lignin due to the increased solubility of the smaller particles. Thus, less solvent would need to be utilised during the lignin separation process and subsequently less solvent would need to be distilled in order to recover the lignin.

It has also been advantageously found that recovering lignin from the solid component improves the purity of lignin separated from biomass material. In the method of U.S. Pat. No. 10,000,891B2, lignin is solubilised and the biomass material is sonicated and hydrolysed in a single step. Accordingly, the aqueous soluble hydrolysed components and lignin are present in a single phase during sonication. The lignin can be separated from the single phase. However, because of inefficiencies in downstream liquid-liquid phase separation steps, there may be an increased risk of hydrolysed components contaminating the separated lignin fraction, in view of the large amounts of hydrolysed components present in the initial liquid mixture. Embodiments of the present invention may be distinguished from e.g. U.S. Pat. No. 10,000,891B2 as the liquid component (L) comprising the hydrolysed components e.g. hemicellulose hydrolysate is first separated from the sonicated mixture, leaving lignin in solid form. By removing e.g. the bulk of the hydrolysed components first, higher purity lignin may be separated from the solid component (S) as lignin is recovered from a medium containing lower amounts of hydrolysed components (these having been separated upstream).

The method of the first aspect of the present disclosure may further comprise the step of separating the solid component (S) from the sonicated mixture.

The separated solid component (S) may be treated to separate lignin from the solid component. Lignin may be separated from the solid component (S) by a process comprising solvent extraction. Lignin may be separated from the solid component (S) by treating the solid component (S) directly by solvent extraction. Alternatively, the solid component (S) may be treated, for example, by a further sonication step. This sonication step may extract lignin into a liquid phase. Solvent extraction may be used to separate lignin from the liquid phase formed as a result of this further sonication step.

In one embodiment, lignin is separated from the solid component (S) by sonicating the solid component (S) in a liquid medium comprising alcohol and water to produce a further sonicated mixture comprising a liquid component comprising dissolved lignin and a solid component comprising cellulose, and extracting lignin from the liquid component of the further sonicated mixture.

The liquid medium may comprise at least 40 weight %, preferably at least 45 weight % water, more preferably at least 50 weight % water. The liquid medium may comprise at most 90 weight % water, preferably at most 85 weight % water, more preferably at most 75 weight % water. The liquid medium may comprise 40 to 90 weight % water, preferably 45 to 85 weight % water, more preferably 55 to 75 weight % water, for example, 50 to 70 weight % water. The liquid medium may consist essentially of water and alcohol. In a preferred embodiment, the liquid medium does not comprise MIBK. When the aqueous medium comprises MIBK, the weight amount of MIBK present may be less than 10%, optionally less than 5%, optionally 4% of MIBK, optionally less than 3%, optionally less than 2%, optionally less than 1%, optionally less than 0.05%.

It has been surprisingly found that lignin can be sonicated and extracted from the solid component into a liquid phase even when the water content of the liquid medium is at least 40 weight %. This is surprising, particularly when water-immiscible solvents, such as ketones (e.g., methyl isobutyl ketone) are absent. This is surprising, as solvent extraction into aqueous alcohol solutions is unexpected, particularly at relatively low temperatures, for example, of below 160 degrees C, preferably 100 to 150 degrees C, more preferably 105 to 120 degrees C.

Without wishing to be bound by any theory, this may be because the lignin in the solid component is of a relatively low molecular weight, for example, having previously been subjected to an earlier sonication step. The separation is also advantageous because it can occur at relatively low temperatures, where the risk of lignin condensation is reduced.

The molecular weight of the lignin produced may be less than 3500 g/mol, preferably 3000 g/mol, for example, less than 2500 g/mol, less than 2000 g/mol or less than 1500 g/mol. In some examples, the molecular weight of the lignin produced may be 100 to 3500 g/mol, preferably 200 to 3000 g/mol, more preferably 250 to 2500 g/mol, even more preferably 300 to 2000g/mol or 300 to 1500 g/ml. The average molecular weight of the lignin produced may be less than 3500 g/mol, preferably 3000 g/mol, for example, less than 2500 g/mol or less than 2000 g/mol. In some examples, the molecular weight of the lignin produced may be 100 to 3500 g/mol, preferably 200 to 3000 g/mol, more preferably 250 to 2500 g/mol, even more preferably 300 to 2000g/mol or 300 to 1500 g/mol. In some examples, the molecular weight or average molecular weight may be 300 to 1000 g/mol. The average molecular weight may be a weight average or number average molecular weight. Molecular weight may be determined by any suitable method including gel permeation chromatography or NMR techniques, for example, Diffusion Ordered Spectroscopy (DOSy).

The alcohol in the liquid medium used to form the further sonicated mixture is preferably methanol. However, other alcohols, such as C₂ to C₈ alcohols, for example, C₂ to C₆ or C₂ to C₄ alcohols may be used. Examples include methanol, ethanol, propanol, butanol, pentanol and hexanol. Methanol and ethanol are preferred, and methanol is most preferred. As mentioned above, ethanol forms an azeotrope with water, making it more difficult to separate effectively from downstream process steps.

The alcohol in the liquid medium used to form the further sonicated mixture may be present in the liquid medium in an amount of 20 to 60 weight %, preferably 25 to 40 weight %, more preferably 30 to 35 weight %. Where methanol is used as the alcohol, the methanol is present in the liquid medium in an amount of 20 to 60 weight %, preferably 25 to 40 weight %, more preferably 30 to 35 weight %. The amount of alcohol may be tailored to optimise the amount of lignin that is extracted into the liquid component of the further sonicated mixture. It has been found that the addition of methanol in the further sonication step can advantageously improve the total yield of lignin recovered from the process.

In some embodiments, weight ratio of the amount of lignin in the liquid component to the amount of lignin in the solid component of the further sonicated mixture is at least about 1:1, preferably at least about 2:1, more preferably at least about 3:1, yet more preferably at least about 4:1, even more at least about 5:1, yet more at least about 6:1, for example, at least about than 7:1. Increasing the amount of alcohol (e.g., methanol) in the further sonication step may increase the proportion of lignin in the liquid component.

Preferably, the liquid medium used to form the further sonication mixture further comprises an acid. The acid may comprise an organic acid, such as an aliphatic carboxylic acid, an aliphatic dicarboxylic acid, an aminocarboxylic acid or an aminodicarboxylic acid. In a preferred embodiment, the acid catalyst is an organic acid with a pH of below 4, preferably below 3.9 at 1 mM concentrations. In some examples, the concentration of acid catalyst present in the aqueous medium is about 1 M or less e.g. about 0.05 M to about 1 M, preferably about 0.05 M to about 0.5 M or about 0.05 M to about 0.3 M, more preferably about 0.1 M to about 0.2 M. In some embodiments, the concentration of the acid catalyst present in the aqueous medium is about 0.1 M or about 0.2 M. In a preferred embodiment, the acid catalyst is oxalic acid catalyst present at a concentration of about 1 M or less e.g. about 0.05 M to about 1 M, preferably about 0.05 M to about 0.5 M or about 0.05 M to about 0.3 M, more preferably about 0.1 M to about 0.2 M. In some embodiments, the concentration of the oxalic acid catalyst present in the aqueous medium is about 0.1 M or about 0.2 M. The acid catalyst may generally have a pKa of less than 5, e.g. from 2 to 5. In the case of a dicarboxylic acid, and especially a dicarboxylic amino acid where the carboxylic acid moieties within the molecule may have different pKa values, at least one of the carboxylic acid moieties should desirably have a pKa of less than 5. Thus, for example, an aliphatic carboxylic acid or an aliphatic dicarboxylic acid may contain 1 to 6 carbon atoms in the molecule, preferably 1 to 4 carbon atoms. Examples of organic carboxylic acids include, but shall not be limited to, acetic acid and formic acid. Such acids are recognised as being weak acids. In some examples, the acid catalyst may be selected from the group consisting of oxalic acid, citric acid, maleic acid, acetic acid, lactic acid, formic acid, ascorbic acid or a mixture thereof. Alternatively, the acid may be a dicarboxylic acid. In a preferred embodiment, the acid catalyst is oxalic acid.

As mentioned above, lignin can be extracted by a process that comprises solvent extraction. Solvent extraction may be carried out using a water-immiscible organic solvent. Examples of suitable water-immiscible organic solvents include ketones and esters. Preferably, the ketone is methyl isobutyl ketone. Suitable esters include ethyl acetate. Lignin may be separated from the water-immiscible solvent, for example, by evaporating the solvent or distilling the solvent, such that the recovered solvent may be reused.

Preferably, alcohol is removed from the further sonicated mixture. The alcohol may be removed by distillation, such that the recovered alcohol can be reused to form the liquid medium for the further sonication step.

In one embodiment, the solid component of the further sonicated mixture may first be separated from the further sonicated mixture. The alcohol may then be removed from the remaining liquid component.

The solid component may be removed from the further sonicated mixture by any suitable method. An example is filtration. The recovered solid may consist of cellulose. In some cases, however, the recovered solid may include solid lignin. This solid lignin may be extracted by solvent extraction. Solvent extraction may be carried out using a water-immiscible organic solvent. Examples of suitable water-immiscible organic solvents include ketones and esters. Preferably, the ketone is methyl isobutyl ketone. Suitable esters include ethyl acetate.

Once the solid component is separated from the further sonicate mixture, the remaining liquid component may contain dissolved lignin, alcohol, and water. The liquid component may also include acid and/or dissolved hemicellulose hydrosylate. The alcohol may be removed, for example, by distillation. Distillation allows the recovered alcohol can be reused.

Once the alcohol is removed, the remaining liquid component contains dissolved lignin and water. The lignin may be separated, for example, by solvent extraction. Solvent extraction may be carried out using a water-immiscible organic solvent. Examples of suitable water-immiscible organic solvents include ketones and esters. Preferably, the ketone is methyl isobutyl ketone. Suitable esters include ethyl acetate.

Once lignin is extracted, the remaining aqueous component may include optional acid and/or dissolved hemicellulose hydrosylate. It may be possible to separate the acid from the hemicellulose hydrosylate. A suitable method is nanofiltration. The recovered acid may be reused in one of the preceding sonication steps. Alternatively, if little hemicellulose hydrosylate is present, the acid may be recovered, for example, by evaporation of the water.

Instead of removing the solid component of the further sonication mixture prior to alcohol removal, it may be possible to remove the solid component downstream. In this embodiment, alcohol may be removed from the further sonication mixture. The alcohol may be removed, for example, by distillation. Distillation allows the recovered alcohol can be reused.

Once alcohol is removed, the resulting mixture includes cellulose, dissolved and solid lignin and water. Acid and hemicellulose hydrosylate may also be present. Lignin may be extracted from the mixture, for example, by solvent extraction. Solvent extraction may be carried out using a water-immiscible organic solvent. Examples of suitable water-immiscible organic solvents include ketones and esters. Preferably, the ketone is methyl isobutyl ketone. Suitable esters include ethyl acetate.

Once lignin is extracted, the remaining mixture comprises cellulose, acid and water. Cellulose may be separated, for example, by filtration. The acid may be recovered from any hemicellulose hydrosylate by, for example, nanofiltration. Alternatively, if little hemicellulose hydrosylate is present, the acid may be recovered, for example, by evaporation of the water.

In an alternative embodiment, the further sonication step may be omitted and the lignin may be separated by treating the solid component (S) from the first sonication to extract the lignin.

Lignin may be extracted from the mixture, for example, by solvent extraction. Solvent extraction may be carried out using a water-immiscible organic solvent. Examples of suitable water-immiscible organic solvents include ketones and esters. Preferably, the ketone is methyl isobutyl ketone. Suitable esters include ethyl acetate.

In one example, the solid component (S) can be treated with a ketone and alcohol to form a further mixture comprising a second solid component (S′) comprising cellulose and a second liquid component (L′) comprising lignin. The method may further comprise separating the second solid component (S′) and the second liquid component (L′). In some embodiments, the second solid component (S′) comprising cellulose may be separated by filtration. The second solid component (S′) may then be washed and/or dried. In some examples, cellulose can be obtained, for example, in the form of wood pulp. The second solid component (S′) may also comprise other components from the solid component (S). For example, the second solid component (S′) may comprise lignin and/or ash from the solid component (S).

As explained above, in some embodiments, the method further comprises the step of separating the solid component (S) from the first sonicated mixture and treating the solid component (S) with a ketone and alcohol to form a further mixture comprising a second solid component (S′) comprising cellulose and a second liquid component (L′) comprising lignin. In a preferred embodiment, the ketone is selected from the group consisting of methyl ethyl ketone, methyl isopropyl ketone, methyl propyl ketone, methyl butyl ketone, methyl isobutyl ketone (MIBK), methyl isoamylketone, diethyl ketone, dimethyl ketone (acetone), diacetone alcohol (DAA), diisobutyl ketone (DIBK), ethyl isopropyl ketone, ethyl propyl ketone, and ethyl isobutyl ketone, or a mixture thereof. Preferably, the ketone is methyl isobutyl ketone (MIBK).

In a preferred embodiment, the alcohol may have less than about 4 carbon atoms. The alcohol may be selected from the group consisting of methanol, ethanol, propanol, isopropanol and butanol. In a preferred embodiment, the alcohol is selected from the group consisting of methanol, propanol, isopropanol and butanol. In some embodiments, the alcohol does not comprise ethanol. Preferably, the alcohol is methanol. It has been found that, the alcohol, such as methanol, acts as a wetting agent to facilitate extraction of lignin present in the second solid component (S′) into the ketone, such as MIBK.

In some embodiments, the alcohol may be a primary, secondary or tertiary alcohol. In some examples, the alcohol may have a boiling point of less than 125° C. In some examples, the alcohol may have less than about 4 carbon atoms. For example, the alcohol may be selected from the group consisting of methanol, ethanol, propanol, isopropanol, butanol, butan-2-ol, t-butanol, or mixtures thereof. In a preferred embodiment, the alcohol is methanol.

The ketone and alcohol may be present at a weight ratio of about 1 to 10:1, optionally about 1 to 5:1, optionally about 1:1. In a preferred embodiment, MIBK and methanol are present at a weight ratio of about 1 to 10:1, optionally about 1 to 5:1, optionally about 1:1.

In some examples, at least 50 wt. % of lignin from the solid component (S) is extracted into the second liquid component (L′). In a preferred embodiment, at least 65 wt. % (e.g. at least 75 wt. % or at least 85 wt. %) of lignin from the solid component (S) is extracted into the second liquid component (L′). In some examples, the mass to volume ratio of the second solid component (S′) to the second liquid component (L′) is about 1:1 to 10 w/v, optionally about 1:1 to 5 w/v, optionally about 1:1 to 3 w/v, optionally about 1:1.5 w/v.

In some embodiments, the second liquid component (L′) comprising lignin is separated. In preferred embodiments, lignin is separated from the second liquid component (L′). The second liquid component (L′) may comprise residual water from solid component (S). For example, the second liquid component (L′) may comprise water, methanol and MIBK, e.g. in a single phase. The second liquid component (L′) may also comprise hemicellulose hydrolysate, glucose and/or acid catalyst from the solid component (S). However, in contrast with, for example, the process of U.S. Pat. No. 10,000,891 B2, the amount of hemicellulose hydrolysate, glucose and/or acid catalyst present is significantly less (e.g. because the bulk of the hemicellulose hydrolysate may be removed upstream).

In a preferred embodiment, the alcohol (preferably methanol) is removed from the second liquid component (L′) by conventional techniques, for example, by distillation. It has been advantageously found that using methanol enables an energy efficient process as methanol requires lower operating temperatures for distillation due to its low boiling point. Furthermore, an advantage of methanol over e.g. ethanol is that methanol does not form an azeotrope with water. Accordingly, methanol may be separated by e.g. distillation, allowing methanol to be recycled and reused in the process.

Once alcohol (e.g. methanol) is separated from the second liquid component (L′), the remaining liquid component comprises an organic component (O) comprising lignin and an aqueous component (A). The organic component (O) comprising lignin and the aqueous component (A) form immiscible phases that can be separated. For example, the method may further comprise separating the organic component (O) comprising lignin and the aqueous component (A) by conventional techniques, such as liquid-liquid phase separation. The lignin can then be separated from the organic component (O). Any suitable technique may be used, for example, the ketone may be evaporated off. In some examples, the separated lignin has an average molecular weight of less than about 3000 g/mol e.g. less than about 2000 g/mol or less than about 1500 g/mol. In some examples, the separated lignin may have an average molecular weight of between about 500 to about 3000 g/mol e.g. between 500 g/mol to about 1500 g/mol. The separated aqueous component (A) may comprise hemicellulose hydrolysate, glucose and/or acid catalyst.

For example, as described in relation to the first aspect, the biomass material may be treated with the aqueous medium to form a slurry. After sonication, components of the biomass material may be hydrolysed to form soluble components that dissolve in the liquid component (L) of the slurry. Insoluble components, including lignin and cellulose remain as the solid component (S) of the slurry. Instead of recovering lignin from this solid component, it may be possible to use the solid component (S) to form a composite material. The composite material may comprise lignin and cellulose and an acid, wherein the lignin and cellulose are present in a weight ratio of about 1:1 to 5. The lignin and cellulose may be present in a weight ratio of about 1:1 to 3, preferably about 1:2.

The composite material may also comprise water. In some examples, the composite material comprises water at a weight amount of between about 50-90 wt. % e.g. between about 55-85 wt. %.

In some examples, the acid is an organic acid. The acid may have a pH of below 4, preferably below 3.9 at 1 mM concentrations. In a preferred embodiment, the acid is selected from the group consisting of oxalic acid, citric acid, maleic acid, acetic acid, lactic acid, formic acid, ascorbic acid, or a mixture thereof. In a preferred embodiment, the acid is oxalic acid. In an embodiment, the composite material comprises no more than about 40 wt. % of lignin and more than about 60 wt. % of cellulose. In a preferred embodiment, the composite material comprises about 30-35 wt. % of lignin and about 60-65 wt. % of cellulose.

Without being bound by any theory, it is believed that, whilst the lignin has been broken down into smaller particles during sonication, the acid present in the slurry binds to its active sites, thus stabilising the lignin particles and preventing its active sites to re-bind into bigger particles and/or to cellulose particles present in the slurry. In other words, the lignin is thought to be acid stabilised, and forms a composite material with cellulose with unique characteristics than exhibited from other mixtures of cellulose and lignin. The lignin present in the composite material may have an average molecular weight of less than about 3000 g/mol e.g. less than about 2000 g/mol or less than about 1500 g/mol. In some examples, the lignin present in the composite material may have an average molecular weight of between about 500 to about 3000 g/mol e.g. between 500 g/mol to about 1500 g/mol. The reactivity of the composite material described herein may be dependent on several factors. For example, the reactivity may be affected by the lignin molecular weight fractions present in the composite material.

The composite material has been surprisingly found to exhibit unique characteristics. For example, the composite material has the ability to form flexible and mouldable composite structures which, upon drying e.g. applying heat, can firmly retain its structure. For example, the hard material obtained after drying will retain its shape when released from the mould, along with any texture present in the mould. In some examples, the composite material may have beneficial uses in construction. For example, the composite material may be used as mouldable wood in a variety of applications.

The separation of lignin from the solid component (S) from the first sonication step may be regarded as a method of preparing lignin. The method comprises treating a solid component (W), comprising lignin with a ketone and methanol to form a mixture comprising a second solid component (W′) and a liquid component (X′) comprising lignin.

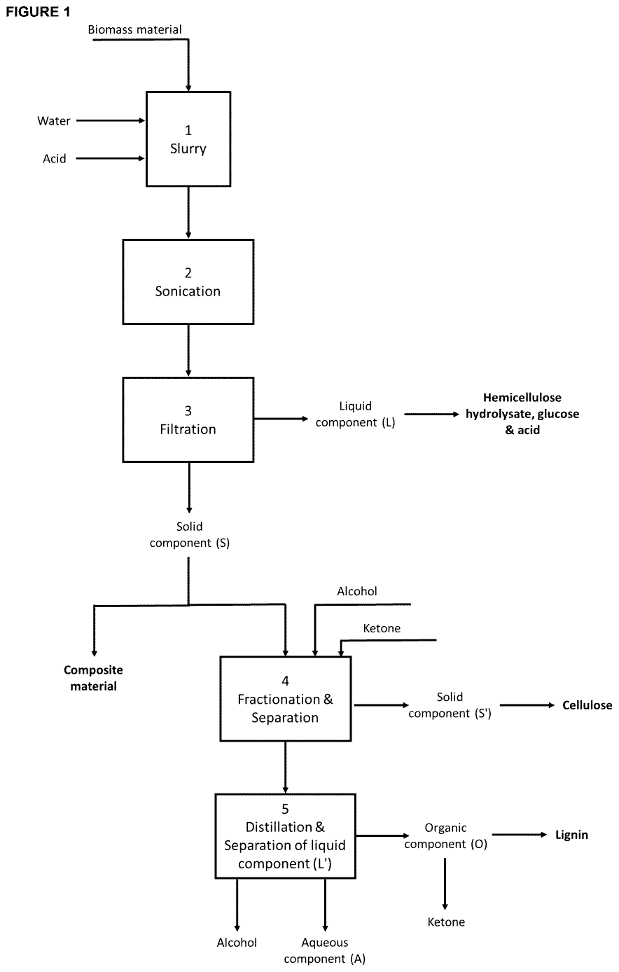

In some examples, the solid component (W) can be obtained from the process described according to the first aspect, e.g. the solid component (W) can be the same as the solid component (S) described herein. In a preferred embodiment, the solid component (W) is the solid component (S) obtained by the process described with reference to FIG. 1.

In some examples, the liquid component (X) can be obtained from the process described according to the first aspect, e.g. the liquid component (X) can be the same as the liquid component (L′) described herein. In a preferred embodiment, the liquid component (X) is the liquid component (L′) obtained by the process described with reference to FIG. 1.

In some embodiments, the solid component (W) may further comprise cellulose, and the second solid component (W′) may comprise cellulose. The cellulose may be separated by filtration. The second solid component (W′) may then be washed and/or dried. In some examples, cellulose is obtained, for example, in the form of wood pulp. The second solid component (W′) may also comprise other components from the solid component (W). For example, the second solid component (W′) may comprise lignin and/or ash from the solid component (W).

In a preferred embodiment, the ketone is selected from the group consisting of methyl ethyl ketone (MEK), methyl isopropyl ketone, methyl propyl ketone, methyl butyl ketone, methyl isobutyl ketone (MIBK), methyl isoamylketone, diethyl ketone, dimethyl ketone (acetone), diacetone alcohol (DAA), diisobutyl ketone (DIBK), ethyl isopropyl ketone, ethyl propyl ketone, and ethyl isobutyl ketone, or a mixture thereof. In a preferred embodiment, the ketone is MIBK.

In a preferred embodiment, the alcohol may have less than about 4 carbon atoms. The alcohol may be selected from the group consisting of methanol, ethanol, propanol, isopropanol and butanol. In a preferred embodiment, the alcohol is selected from the group consisting of methanol, propanol, isopropanol and butanol. In some embodiments, the alcohol does not comprise ethanol. Preferably, the alcohol is methanol. It has been found that, the alcohol, such as methanol, acts as a wetting agent to facilitate extraction of lignin present in the second solid component (S′) into the ketone, such as MIBK.

In some embodiments, the alcohol may be a primary, secondary or tertiary alcohol. In some examples, the alcohol may have a boiling point of less than 125° C. In some examples, the alcohol may have less than about 4 carbon atoms. For example, the alcohol may be selected from the group consisting of methanol, ethanol, propanol, isopropanol, butanol, butan-2-ol, t-butanol, or mixtures thereof. In a preferred embodiment, the alcohol is methanol.

The ketone and alcohol may be present at a weight ratio of about 1 to 10:1, optionally about 1 to 5:1, optionally about 1:1. In a preferred embodiment, MIBK and methanol are present at a weight ratio of about 1 to 10:1, optionally about 1 to 5:1, optionally about 1:1. Alternatively, the ketone and alcohol may be present at a weight ratio of about 1:1 to 5.

In some examples, at least 50 wt. % of lignin from the solid component (W) is extracted into the second liquid component (X). In a preferred embodiment, at least 65 wt. % of lignin from the solid component (W) is extracted into the second liquid component (X). In some examples, the mass to volume ratio of the second solid component (W′) to liquid component (X) is about 1:1 to 10 w/v, optionally about 1:1 to 5 w/v, optionally about 1:1 to 3 w/v, optionally about 1:1.5 w/v.

In some embodiments, the liquid component (X) comprising lignin is separated. In preferred embodiments, lignin is separated from the second liquid component (X). The second liquid component (X) may comprise residual water from solid component (W). For example, the second liquid component (X) may comprise water, methanol and MIBK, e.g. in a single phase. The second liquid component (X) may also comprise hemicellulose hydrolysate, glucose and/or acid catalyst from the solid component (W). However, in contrast with, for example, the process of U.S. Pat. No. 10,000,891 B2, the amount of hemicellulose hydrolysate, glucose and/or acid catalyst present is significantly less (e.g. because the bulk of the hemicellulose hydrolysate and/or glucose may be removed upstream).

In a preferred embodiment, the alcohol (preferably methanol) is removed from the second liquid component (X) by conventional techniques, for example, by distillation. It has been advantageously found that using methanol enables an energy efficient process as methanol requires lower operating temperatures for distillation due to its low boiling point. Furthermore, an advantage of methanol over e.g. ethanol is that methanol does not form an azeotrope with water. Accordingly, methanol may be separated by e.g. distillation, allowing methanol to be recycled and reused in the process.

Once alcohol (e.g. methanol) is separated from the second liquid component (X), the remaining liquid component comprises an organic component (Y) comprising lignin and an aqueous component (Z). The organic component (Y) comprising lignin and the aqueous component (Z) form immiscible phases that can be separated. For example, the method may further comprise separating the organic component (Y) comprising lignin and the aqueous component (Z) by conventional techniques, such as liquid-liquid phase separation. The lignin can then be separated from the organic component (Y). Any conventional technique may be used, for example, the ketone may be evaporated off. In some examples, the separated lignin has an average molecular weight of less than about 3000 g/mol e.g. less than about 2000 g/mol or less than about 1500 g/mol. In some examples, the separated lignin may have an average molecular weight of between about 500 to about 3000 g/mol e.g. between 500 g/mol to about 1500 g/mol. The separated aqueous component (Z) may also comprise hemicellulose hydrolysate, glucose and/or acid catalyst.

According to a second aspect of the present invention, there is provided a method of fractionating a biomass material. The method comprises sonicating a solid component (S) comprising lignin and cellulose in a liquid medium comprising alcohol and at least 40 weight % water to produce a sonicated mixture comprising a liquid component comprising dissolved lignin and a solid component comprising cellulose, and separating lignin from the liquid component of the sonicated mixture by solvent extraction using an organic solvent.

The liquid medium comprises at least 40 weight %, preferably at least 45 weight % water, more preferably at least 50 weight % water. The liquid medium may comprise at most 90 weight % water, preferably at most 85 weight % water, more preferably at most 75 weight % water. The liquid medium may comprise 40 to 90 weight % water, preferably 45 to 85 weight % water, more preferably 50 to 75 weight % water, for example, 55 or 60 to 70 weight % water. The liquid medium may consist essentially of water and alcohol. In a preferred embodiment, the liquid medium does not comprise MIBK. When the aqueous medium comprises MIBK, the weight amount of MIBK present may be less than 10%, optionally less than 5%, optionally 4% of MIBK, optionally less than 3%, optionally less than 2%, optionally less than 1%, optionally less than 0.05%.

It has been surprisingly found that lignin can be sonicated and extracted from the solid component into a liquid phase even when the water content of the liquid medium is at least 40 weight %. This is surprising, particularly when water-immiscible solvents, such as ketones (e.g., methyl isobutyl ketone) are absent. This is surprising, as solvent extraction into aqueous alcohol solutions is unexpected, particularly at relatively low temperatures, for example, of below 160 degrees C., preferably 100 to 150 degrees C., more preferably 105 to 120 degrees C.

Without wishing to be bound by any theory, this may be because the lignin in the solid component is of a relatively low molecular weight. The lignin may have a relatively low molecular weight because of having previously been subjected to an earlier sonication step. The separation is also advantageous because it can occur at relatively low temperatures, where the risk of lignin condensation is reduced.

The molecular weight of the lignin produced may be less than 3500 g/mol, preferably 3000 g/mol, for example, less than 2500 g/mol, less than 2000 g/mol or less than 1500 g/mol. In some examples, the molecular weight of the lignin produced may be 100 to 3500 g/mol, preferably 200 to 3000 g/mol, more preferably 250 to 2500 g/mol, even more preferably 300 to 2000 g/mol or 300 to 1500 g/ml. The average molecular weight of the lignin produced may be less than 3500 g/mol, preferably 3000 g/mol, for example, less than 2500 g/mol or less than 2000 g/mol. In some examples, the molecular weight of the lignin produced may be 100 to 3500 g/mol, preferably 200 to 3000 g/mol, more preferably 250 to 2500 g/mol, even more preferably 300 to 2000 g/mol or 300 to 1500 g/mol. In some examples, the molecular weight or average molecular weight may be 300 to 1000 g/mol. The average molecular weight may be a weight average or number average molecular weight. Molecular weight may be determined by any suitable method including gel permeation chromatography or NMR techniques, for example, Diffusion Ordered Spectroscopy (DOSy).

The alcohol in the liquid medium used to form the further sonicated mixture is preferably methanol. However, other alcohols, such as C₂ to C₈ alcohols, for example, C₂ to C₆ or C₂ to C₄ alcohols may be used. Examples include methanol, ethanol, propanol, butanol, pentanol and hexanol. Methanol and ethanol are preferred, and methanol is most preferred. As mentioned above, ethanol forms an azeotrope with water, making it more difficult to separate effectively from downstream process steps.

The alcohol in the liquid medium used to form the sonicated mixture of the second aspect of the invention may be present in the liquid medium in an amount of 20 to 60 weight %, preferably 25 to 40 weight %, more preferably 30 to 35 weight %. Where methanol is used as the alcohol, the methanol is present in the liquid medium in an amount of 20 to 60 weight %, preferably 25 to 40 weight %, more preferably 30 to 35 weight %. The amount of alcohol may be tailored to optimise the amount of lignin that is extracted into the liquid component of the sonicated mixture.

In some embodiments, weight ratio of the amount of lignin in the liquid component to the amount of lignin in the solid component of the sonicated mixture is at least about 1:1, preferably at least about 2:1, more preferably at least about 3:1, yet more preferably at least about 4:1, even more preferably at least about 5:1, yet more preferably at least about 6:1, for example, at least about 7:1. In some embodiments, the ratio is about 1 to 10:1. In some embodiments, the ratio of the amount of lignin in the liquid component to the amount of lignin in the solid component is about 1:1 to about 9:1, optionally about 2:1 to about 5:1.

Preferably, the liquid medium used to form the sonication mixture comprises an acid. The acid may comprise an organic acid, such as an aliphatic carboxylic acid, an aliphatic dicarboxylic acid, an aminocarboxylic acid or an aminodicarboxylic acid. In a preferred embodiment, the acid catalyst is an organic acid with a pH of below 4, preferably below 3.9 at 1 mM concentrations. In some examples, the concentration of acid catalyst present in the aqueous medium is about 1 M or less e.g. about 0.005 M to about 1 M, preferably about 0.02 M to about 0.5 M or about 0.05 M to about 0.3 M, more preferably about 0.1 M to about 0.2 M. In some embodiments, the concentration of the acid catalyst present in the aqueous medium is about 0.1 M or about 0.2 M. In a preferred embodiment, the acid catalyst is oxalic acid catalyst present at a concentration of about 1 M or less e.g. about 0.005 M to about 1 M, preferably about 0.02 M to about 0.5 M or about 0.05 M to about 0.3 M, more preferably about 0.1 M to about 0.2 M. In some embodiments, the concentration of the oxalic acid catalyst present in the aqueous medium is about 0.1 M or about 0.2 M. The acid catalyst may generally have a pKa of less than 5, e.g. from 2 to 5. In the case of a dicarboxylic acid, and especially a dicarboxylic amino acid where the carboxylic acid moieties within the molecule may have different pKa values, at least one of the carboxylic acid moieties should desirably have a pKa of less than 5. Thus, for example, an aliphatic carboxylic acid or an aliphatic dicarboxylic acid may contain 1 to 6 carbon atoms in the molecule, preferably 1 to 4 carbon atoms. Examples of organic carboxylic acids include, but shall not be limited to, acetic acid and formic acid. Such acids are recognised as being weak acids. In some examples, the acid catalyst may be selected from the group consisting of oxalic acid, citric acid, maleic acid, acetic acid, lactic acid, formic acid, ascorbic acid or a mixture thereof. Alternatively, the acid may be a dicarboxylic acid. In a preferred embodiment, the acid catalyst is oxalic acid.

As mentioned above, lignin can be extracted by a process that comprises solvent extraction. Solvent extraction may be carried out using a water-immiscible organic solvent. Examples of suitable water-immiscible organic solvents include ketones and esters. Preferably, the ketone is methyl isobutyl ketone. Suitable esters include ethyl acetate. Lignin may be separated from the water-immiscible solvent, for example, by evaporating the solvent or distilling the solvent, such that the recovered solvent may be reused.

Preferably, alcohol is removed from the sonicated mixture. The alcohol may be removed by distillation, such that the recovered alcohol can be reused.

In one embodiment, the solid component of the sonicated mixture may first be separated from the sonicated mixture. The alcohol may then be removed from the remaining liquid component.

The solid component may be removed from the sonicated mixture by any suitable method. An example is filtration. The recovered solid may consist of cellulose. In some cases, however, the recovered solid may include solid lignin. This solid lignin may be extracted by solvent extraction. Solvent extraction may be carried out using a water-immiscible organic solvent. Examples of suitable water-immiscible organic solvents include ketones and esters. Preferably, the ketone is methyl isobutyl ketone. Suitable esters include ethyl acetate.

Once the solid component is separated from the sonicate mixture, the remaining liquid component may contain dissolved lignin, alcohol, and water. The liquid component may also include acid and/or dissolved hemicellulose hydrosylate. The alcohol may be removed, for example, by distillation. Distillation allows the recovered alcohol can be reused.

Once the alcohol is removed, the remaining liquid component contains dissolved lignin and water. The lignin may be separated, for example, by solvent extraction. Solvent extraction may be carried out using a water-immiscible organic solvent. Examples of suitable water-immiscible organic solvents include ketones and esters. Preferably, the ketone is methyl isobutyl ketone. Suitable esters include ethyl acetate.

Once lignin is extracted, the remaining aqueous component may include optional acid and/or dissolved hemicellulose hydrosylate. It may be possible to separate the acid from the hemicellulose hydrosylate. A suitable method is nanofiltration. The recovered acid may be reused in one of the preceding sonication steps. Alternatively, if little hemicellulose hydrosylate is present, the acid may be recovered, for example, by evaporation of the water.

Instead of removing the solid component of the sonication mixture prior to alcohol removal, it may be possible to remove the solid component downstream. In this embodiment, alcohol may be removed from the sonication mixture. The alcohol may be removed, for example, by distillation. Distillation allows the recovered alcohol can be reused.

Once alcohol is removed, the resulting mixture includes cellulose, dissolved and solid lignin and water. Acid and hemicellulose hydrosylate may also be present. Lignin may be extracted from the mixture, for example, by solvent extraction. Solvent extraction may be carried out using a water-immiscible organic solvent. Examples of suitable water-immiscible organic solvents include ketones and esters. Preferably, the ketone is methyl isobutyl ketone. Suitable esters include ethyl acetate.

Once lignin is extracted, the remaining mixture comprises cellulose, acid and water. Cellulose may be separated, for example, by filtration. The acid may be recovered from any hemicellulose hydrosylate by, for example, nanofiltration. Alternatively, if little hemicellulose hydrosylate is present, the acid may be recovered, for example, by evaporation of the water.

The solid component (S) comprising lignin and cellulose employed in the second aspect of the present invention may be produced by dispersing biomass material in an aqueous medium to form a slurry, and sonicating the slurry to produce a sonicated mixture comprising a liquid component and the solid component (S) comprising lignin and cellulose. The aqueous medium used to form the slurry may comprise at least 80 weight % water, and/or comprises alcohol, preferably, methanol and water.

This sonication step may be the sonication step used in the first aspect of the invention.

Described herein is the use of sonication as an energy source, e.g. the use of ultrasound. In some examples, the ultrasound used will generally operate at a frequency in the range of from about 10 to about 250 kHz, preferably from about 10 to about 100 kHz, preferably from about 10 to about 50 kHz, preferably from about 20 to 30 about kHz. The ultrasonic energy may be applied continuously or in a discontinuous manner, such as by pulsed application. Any suitable source of ultrasonic irradiation may be used. An ultrasonic probe may, for example, be inserted into a mixing vessel, such as a continuous ultrasonic flow cell, an ultrasonic emitter may be contained in the mixing vessel, or the mixing vessel may be housed in an ultrasonic bath or it may have an ultrasound transducer fixed to the external walls of the mixing vessel.

The methods described herein may comprise a continuous process or a batch process. For use on a large plant scale a continuous process is preferred. However, in one aspect of the present invention it is envisaged that biomass may be treated at or close to source, in which case a batch process may be desirable. Indeed, it is a particular aspect of the present invention that we provide a process which may be utilised on a small scale locally to where the biomass is sourced.

The process of the reaction may include an additional energy source, i.e. in addition to sonication. A variety of additional energy sources may be utilised, such as thermal energy. However, it is a particular advantage of the present invention that the sonication is conducted at a temperature of from about 90° C. to about 150° C., optionally about 110° C. to about 140° C., optionally about 120° C. to about 130° C.

The process of the present invention may be desirably carried out at elevated pressure.

The methods described herein are advantageous in that, inter alia, a large proportion of the materials employed in the method described herein is recyclable, for example, there may be as much as 95% recovery of the materials e.g. solvents, acid, etc used in the method of the invention. For example, up to about 99% of solvent used in the process can be recovered. In particular, since, as hereinbefore described, oxalic acid is a solid at room temperature (melting point 189-191° C.) it can therefore be recovered (e.g. up to about 90% of recovery) and reused in an efficient and clean manner through simple crystallisation and filtration, or through chromatographic separation.

These and other aspects of the present invention will now be described with reference to the accompanying drawings.

Referring to FIG. 1, biomass material, water and acid are formed into a slurry 1. The slurry is then subjected to sonication 2. This sonication produces a sonicated mixture comprising a solid component (S) comprising lignin and cellulose and a liquid component (L), Under the sonication conditions, hemicellulose in the biomass is hydrolysed to form soluble hemicellulose hydrolysates (e.g. sugars), which are dissolved in the liquid component. The bulk of the lignin remains in the solid phase, together with the cellulose. The weight ratio of lignin in the solid component to the weight of lignin in the liquid component is at least 2:1, preferably at least 5:1, more preferably at least 10:1. Preferably, at least 90% of the lignin in the biomass material remains in the solid component of the sonicated mixture.

The solid component (S) is separated by filtration 3. The liquid component (L) comprises hemicellulose hydrosylate (e.g., glucose) and acid. The hemicellulose hydrosylate (e.g., glucose) may be separated from the acid, for example, by nanofiltration. The hemicellulose hydrosylate (e.g., glucose) may be used as a feedstock, for example, for the synthesis of compounds traditionally synthesised from petrochemical feedstocks. The acid may be reused in the sonication step.

The solid component (S) may be used as or to form a composite material.

Alternatively or additionally, the solid component (S) may be treated with a mixture of an alcohol (e.g. methanol) and ketone (methyl isobutyl ketone). This ketone extracts lignin from the solid component (S) by solvent extraction 4, leaving a further solid component (S′). The further solid component (S′) may be separated, for example, by filtration. The further solid component (S′) may consist essentially of cellulose.

Once the solid component (S′) is removed, the remaining liquid may be allowed to phase separate into an organic and aqueous phase. The lignin dissolved in the ketone forms the organic phase. Lignin may be isolated from this phase by distilling off the ketone and leaving the lignin as a solid. The aqueous phase may be separated by distillation. Where the alcohol is methanol, separation of methanol from water is more efficient than, for example, where ethanol is used because methanol does not form an azeotrope with water. The recovered ketone and alcohol may be reused.

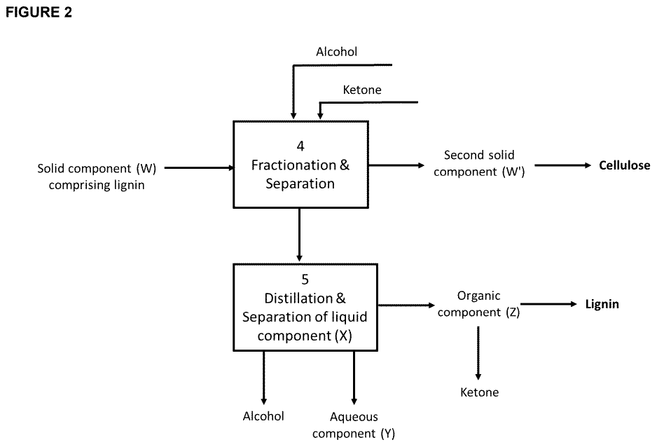

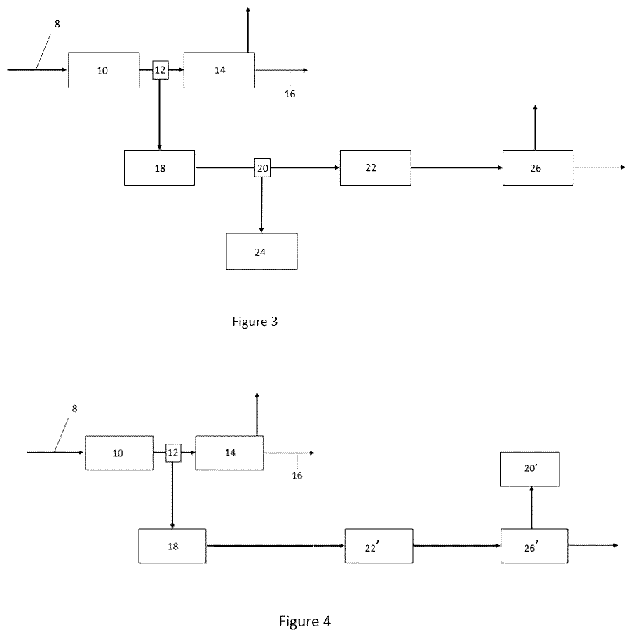

FIG. 2 shows how a solid component comprising lignin and cellulose may be purified. The solid component (W) may be produced in the manner of solid component (S) as described with reference to FIG. 1 above. Alternatively, solid component (W) may be obtained from a different source. The solid component (W) may be treated with a mixture of an alcohol (e.g. methanol) and ketone (methyl isobutyl ketone). This ketone extracts lignin from the solid component (W) by solvent extraction 4, leaving a further solid component (W′). The further solid component (W′) may be separated, for example, by filtration. The further solid component (W′) may consist essentially of cellulose.

Once the solid component (W′) is removed, the remaining liquid may be allowed to phase separate into an organic and aqueous phase. The lignin dissolved in the ketone forms the organic phase. Lignin may be isolated from this phase by distilling off the ketone and leaving the lignin as a solid. The aqueous phase may be separated by distillation. Where the alcohol is methanol, separation of methanol from water is more efficient than, for example, where ethanol is used because methanol does not form an azeotrope with water. The recovered ketone and alcohol may be reused.

Referring to FIG. 3, this figure shows a schematic drawing of another example of a system for fractionating a biomass material.

The system comprises sonicators 10 and 18; filtration units 12 and 20; a nanofiltration unit 14; solvent extraction units 16 and 24; and distillation unit 22.

In use, a slurry comprising the biomass 8 (e.g. wood) and an aqueous medium comprising (e.g., consisting essentially of) water and, optionally, acid (e.g., oxalic acid) is sonicated in sonicator 10. The slurry is sonicated at ultrasonic frequencies of 20 to 25 Hz at a temperature of 115 to 135 degrees C. The sonication produces a sonicated mixture comprising a solid component comprising lignin and cellulose and a liquid component, Under the sonication conditions, hemicellulose in the biomass is hydrolysed to form soluble hemicellulose hydrolysates (e.g. sugars), which are dissolved in the liquid component. The bulk of the lignin remains in the solid phase, together with the cellulose. The weight ratio of lignin in the solid component to the weight of lignin in the liquid component is at least 2:1, preferably at least 5:1, more preferably at least 10:1. Preferably, at least 90% of the lignin in the biomass material remains in the solid component of the sonicated mixture.

The sonicated mixture is filtered through filter 12. The liquid component of the sonicated mixture is the filtrate. This filtrate comprises (e.g., consists essentially of) dissolved hemicellulose hydrolysates (e.g. sugars), optional acid (e.g. oxalic acid) and water. The hemicellulose hydrosylate may be separated from any acid (e.g. oxalic acid) using nanofiltration 14. Any recovered acid may be reused as a catalyst for sonication. The hemicellulose hydrolysates 16 may be separated and used as feedstock for producing e.g., carbon-based fuels, polymers and other chemicals traditionally made from petrochemical feedstocks.

The solid separated by the filter 12 may be dispersed in a liquid medium comprising alcohol (e.g., methanol), and water to form a slurry. The solid separated by the filter comprises cellulose and lignin. The solid may also be wet with e.g. aqueous acid. The solid may also contain hemicellulose, although, preferably, most of the hemicellulose in the biomass material may be removed as hemicellulose hydrosylate in the first sonication step. Optionally, additional acid (e.g. oxalic acid) may be added to the liquid medium. In one example, the liquid medium may contain 30 to 35 weight % methanol. The amount of alcohol may be controlled to optimise the extraction of lignin into the solid and/or liquid phase as explained below.

The slurry is sonicated in sonicator 18 to produce a further sonication mixture. Under the sonication conditions, the lignin is broken up into low molecular weight lignin that dissolves in the liquid phase of the further sonicated mixture Any hemicellulose may also be hydrolysed to form hemicellulose hydrolysates that are also soluble in the liquid phase. The resulting lignin may have a molecular weight of 1600 g/mol or less, for example, 300 to 1500 g/mol. The further sonication mixture comprises a solid component comprising cellulose and a liquid component comprising dissolved lignin.

The solid comprising cellulose may be separated from the further sonication mixture by filtration through filter 20. In some embodiments, solid lignin may be also present in the separated solid, this may be extracted by solvent extraction 24, for example, using a water-immiscible solvent, such as a ketone (methyl isobutyl ketone) or ester. The extracted lignin may be separated from the water-immiscible solvent by removing the solvent by distillation (not shown).

The liquid component of the further sonication mixture comprises dissolved lignin. In addition, the liquid component may comprise alcohol (e.g. methanol), water and, optionally, residual acid employed in one or both of the preceding sonication step(s). The alcohol may be separated from the liquid component, for example, by feeding the liquid component into a distillation unit 22. The distilled alcohol may be reused in the sonicator 18. Where the alcohol is methanol, separation of the methanol may be more efficient that when, for example, ethanol is used because methanol does not form an azeotrope with water.

Once alcohol is removed, the remaining liquid may be treated by solvent extraction in solvent extraction unit 26. Here, lignin may be extracted by solvent extraction 26, for example, using a water-immiscible solvent, such as a ketone (methyl isobutyl ketone) or ester. The extracted lignin may be separated by removing the solvent by distillation (not shown).

Referring to FIG. 4, this is a schematic drawing of an alternative example of a system for fractionating a biomass material. The system is identical to that shown in FIG. 3 and like numerals have been used to describe like parts. However, the filtration unit 20 directly downstream of the second sonicator 18 has been omitted. Instead, alcohol is removed from the sonicated mixture from the second sonicator by distillation in distillation unit 22′ before any solid separation step occurs. Once alcohol is removed, lignin is removed by solvent extraction in the solvent extraction unit 26′. The extracted lignin may be isolated, for example, by distillation of the solvent used in the solvent extraction unit 26′ in a similar manner described in relation to FIG. 3. Once lignin is extracted, solid may be separated by from the remaining liquid by filtration in filtration unit 20′. The residue (not shown) from the filtration unit may comprise or consist essentially of cellulose. The filtrate may comprise water and, optional acid which may be reused in one of the upstream sonicators 10, 18.

In an alternative embodiment (not shown), the slurry that is sonicated in sonicator 10 may be a slurry of biomass dispersed in a liquid medium comprising alcohol (e.g., methanol), and water. The slurry may also include acid (e.g. oxalic acid). In one example, the liquid medium may contain 30 to 35 weight % methanol.

The slurry is sonicated in sonicator 10 to produce a sonication mixture. Under the sonication conditions, the lignin is broken up into low molecular weight lignin that dissolves in the liquid phase of the further sonicated mixture Any hemicellulose may also be hydrolysed to form hemicellulose hydrolysates that are also soluble in the liquid phase. The resulting lignin may have a molecular weight of less than 1600 g/mol, for example, 300 to 1500 g/mol. The sonication mixture comprises a solid component comprising cellulose and a liquid component comprising dissolved lignin.

Alcohol may be removed from the liquid component to provide a liquid mixture comprising dissolved lignin and hemicellulose hydrosylate. Alcohol may be removed by distillation.

The dissolved lignin may be extracted by solvent extraction using a water immiscible solvent, such as a ketone (methyl isobutyl ketone) or ester. The extracted lignin may be separated from the water-immiscible solvent by removing the solvent by distillation. Once lignin is separated, the sugars and acid may be recovered from the remaining solution by nanofiltration.

This solid component of the sonication mixture produced in the sonicator 10 may be separated in filtration unit 12 and fed to the second sonicator 18. In this embodiment, the sonication step in the first sonicator 10 may result in a significant proportion of the lignin being extracted into the liquid component of the sonication mixture. Thus, the ratio of the weight of the lignin in the solid component (S) to the weight of the lignin in the liquid component (L) may be less than 2:1.

Embodiments of the invention will now be described in the following numbered clauses:
1. A method of fractionating a biomass material, said method comprising:
   i. treating the biomass material with an aqueous medium to form a slurry, and
   ii. subjecting the slurry to sonication to produce a sonicated mixture comprising a liquid component (L) and a solid component (S) comprising lignin and cellulose, wherein, when the aqueous medium comprises ethanol and methyl isobutyl ketone (MIBK), the combined weight amount of ethanol and MIBK in the aqueous medium is less than 40%.
2. A method of fractionating a biomass material, said method comprising:
   i. treating the biomass material with an aqueous medium to form a slurry, and
   ii. subjecting the slurry to sonication to produce a sonicated mixture comprising a liquid component (L) and a solid component (S) comprising lignin and cellulose, wherein ratio of the weight of the lignin in the solid component (S) to the weight of the lignin in the liquid component (L) is greater than 2:1.
3. The method according to clause 1 or clause 2, further comprising separating lignin, cellulose and/or hemicellulose hydrolysate from the sonicated mixture.
4. The method according to any preceding clause, wherein the aqueous medium comprises an acid catalyst.
5. The method according to any preceding clause, wherein the solid component (S) comprises at least 90% of lignin available from the biomass material.
6. The method according to any preceding clause, wherein the liquid component (L) comprises less than 10% of lignin available from the biomass material.
7. The method according to any preceding clause, wherein the ratio of the amount of lignin in the solid component (S) and liquid component (L) is about 1 to 10:1, optionally about 9:1.
8. The method according to any preceding clause, wherein when the aqueous medium comprises MIBK and/or methanol, less than 10 wt. % of MIBK is present and/or less than 30 wt. % of ethanol is present.
9. The method according to any of clauses 4-8, wherein the aqueous medium comprises the acid catalyst and water in a combined weight amount of at least 90 wt. %, optionally wherein the aqueous medium consists essentially of the acid catalyst and water.
10. The method according to any preceding clause, further comprising the steps of:
   i. separating the solid component (S) from the sonicated mixture;
   ii. treating the solid component (S) with a ketone and an alcohol to form a further mixture comprising a second solid component (S′) comprising cellulose and a second liquid component (L′) comprising lignin.
11. A method of preparing lignin, said method comprising:
   treating a solid component (W), comprising lignin with a ketone and an alcohol, to form a mixture comprising a second solid component (W′) and a liquid component (X) comprising lignin.
12. The method according to clause 10 or 11, further comprising separating lignin from the second liquid component (L′) or the second solid component (W′).
13. The method according to any of clauses 10-12, wherein the second liquid component (L′) or liquid component (X) comprises at least 50% of lignin from the solid component (S) or the solid component (W′), optionally at least 60%, optionally at least 65%.
14. The method according to any of clauses 10-13, wherein the mass to volume ratio of the second solid component (S′) to the second liquid component (L′) or the mass to volume ratio of the second solid component (W′) and the liquid component (X) is about 1:1 to 10 w/v, optionally about 1:1 to 5 w/v, optionally about 1:1 to 3 w/v, optionally about 1:1.5 w/v.
15. The method according to any of clauses 10-14, wherein the ketone and alcohol are present in a weight ratio of about 1 to 10:1, optionally about 1 to 5:1, optionally about 1:1.
16. The method according to any of clauses 10-15, wherein the ketone is MIBK and the alcohol is methanol.
17. The method according to claim any of clauses 10-16, further comprising the step of separating the second solid component (S′) and the second liquid component (L′) of the mixture or separating the second solid component (W′) and the liquid component (X) of the mixture.
18. The method according to clause 17, further comprising fractionally distilling the alcohol from the second liquid component (L′) or the liquid component (X).
19. The method according to any of clauses 17-18, further comprising fractionating the second liquid component (L′) into an aqueous component (A) and an organic component (O) comprising lignin, or fractionating the liquid component (X) into an aqueous component (Y) and an organic component (Z) comprising lignin.
20. The method according to any of clauses 17-19, further comprising separating lignin from the organic component (O) or the organic component (Z) by evaporating the ketone.
21. The method according to any of clauses 10-20, wherein the average molecular weight of lignin is less than about 3000 g/mol.
22. A composite material, comprising lignin, cellulose and an acid, wherein the lignin and cellulose are present in a weight ratio of about 1:1 to 5, optionally 1:1 to 3, optionally 1:2.
23. The composite material according to clause 22, wherein the average molecular weight of the lignin is less than about 3000 g/mol.
24. A composite material, according to clauses 22-23, prepared by a method according to any one of claims 1-21.
25. The method or composite material according to any of clauses 4-24, wherein the acid catalyst and/or acid is selected from the group consisting of oxalic acid, citric acid, maleic acid, acetic acid, lactic acid, formic acid, ascorbic acid or a mixture thereof, optionally wherein the acid catalyst and/or acid is oxalic acid.

### EXAMPLES

### Example 1: Biomass Treatment

As illustrated in FIG. 1 herein, an example of a modified process for fractionating biomass comprising the following steps:

### 1—Slurry

Formation of a slurry by treating biomass material in an aqueous medium (e.g. in water). The aqueous medium may also comprise an acid (preferably organic acid) catalyst.

### 2—Sonication

Sonicating the slurry producing a sonicated mixture comprising a liquid component (L) and a solid component (S) comprising lignin and cellulose.

### 3—Filtration

The liquid component (L) and the solid component (S) are separated by filtration. The liquid component (L) is extracted, which comprises hydrolysed components of the biomass material (including e.g. hemicellulose hydrolysate and glucose) and the acid (when the aqueous medium comprises the acid).

Insoluble components, including e.g. lignin and cellulose remain as the solid component (S) of the slurry. The solid component (S) is separated from the sonicated mixture by filtration. The residue can be removed from the process as a composite material and/or the residue can be further treated (in step 4/5) to separate lignin and/or cellulose from the solid component (S). If the residue is removed from the process, it may then be washed and dried. Both alternatives of the process can occur at the same time, for example, a partial amount of the residue can be removed whilst the remaining amount continues in the process. Alternatively, all the residue can be removed as the composite material or all the residue can continue in the process.

### 4—Fractionation & Separation

The solid component (S) can then be treated with a ketone and an alcohol to form a further mixture comprising a second solid component (S′) comprising cellulose and a second liquid component (L′) comprising lignin. The ketone and alcohol may be MIBK and methanol. The insoluble components, including cellulose form the second solid component (S′) and the soluble components, including lignin form the second liquid component (L′). The second solid component (S′) can be removed by filtration and may be further washed and/or dried to separate cellulose.

5—Distillation & Separation of liquid component (L′)

The second liquid component (L′) is further treated to separate the lignin. The alcohol (e.g. methanol) may be fractionally distilled from the second liquid component (L′) and can be recycled and reused in the process. The second liquid component (L′) may be separated into an aqueous component (A) and an organic component (O) comprising lignin. The ketone (e.g. MIBK) present in the organic component may then be evaporated off, and lignin may be separated.

As described herein, removing the liquid component (L) comprising the soluble hydrolysed components in step 2 can result in a significantly higher purity of lignin obtained during step 5. This is because a significant proportion of the soluble hydrolysed components are separated from the lignin before lignin recovery is carried out in steps 4 and 5. This contrasts with, for example, U.S. Pat. No. 10,000,891B2, where lignin is recovered directly from a single-phase liquid mixture comprising lignin and hydrolysed components (e.g. hemicellulose hydrolysate). It can be more difficult to separate such hydrolysed components from the lignin due to greater amounts of hydrolysed components in contact with the lignin, and inefficiencies in downstream liquid-liquid phase separation steps. In one example, it was found that lignin separated from a process as described in relation to FIG. 1 was analysed and found to contain less than 1 weight % hemicellulose hydrolysate. Furthermore, the lignin obtained may have relatively lower average molecular weights, such as less than about 3000 g/mol e.g. less than about 2000 g/mol or less than about 1500 g/mol. In some examples, the lignin obtained may have an average molecular weight of between about 500 g/mol to about 3000 g/mol e.g. between 500 g/mol to about 1500 g/mol. This can be contributed to the improved sonication causing the insoluble particles (including lignin) to be broken down more effectively. In one example, the lignin separated from a process as described in relation to FIG. 1 was found to be soluble in ethanol: a reflection of the low molecular weights achieved by improved sonication in the absence of e.g. MIBK and ethanol in the sonicated slurry.

In a further example, a biomass material sample was obtained, of 50 kg at 50% moisture and less than 5 mm in size. The biomass material comprised approximately 25 wt. % of lignin, 25 wt. % of hemicelluloses, 47 wt. % of cellulose and 3 wt. % of ash. Water (300 L) and oxalic acid (5.4 kg, 0.2 M strength) was added and blended with the biomass material. The mixture was blended for approximately two hours with a heat up from 15° C. to about 120° C.-130° C., at an uncontrolled pressure of maximum 2.7 Barg (gauge pressure). The mixture was then sonicated at a frequency of 25 kHz with a power of 4 kW for about 4 hours at a temperature of 120° C.-130° C.

### Example 2: Lignin Preparation

As illustrated in FIG. 2 herein, an example of a modified process for preparing lignin comprises the following steps:
4—Fractionation & Separation

A solid component (W) comprising lignin is treated with a ketone and an alcohol to form a mixture comprising a second solid component (W′) and a second liquid component (X) comprising lignin. The ketone and alcohol may be MIBK and methanol, respectively. The soluble components, including lignin, form the second liquid component (L′). The solid component (W) can be obtained from the process described according to the first aspect, e.g. the solid component (W) can be the same as the solid component (S) described herein. In some examples, the solid component (W) is the solid component (S) obtained by the process illustrated (by way of example) in FIG. 1.

Accordingly, the solid component (W) may comprise cellulose. In these examples, the insoluble components, including cellulose form the second solid component (W′). The second solid component (W′) can be removed by filtration and may be further washed and/or dried to separate cellulose.

5—Distillation & Separation of liquid component (X)

The liquid component (X) is further treated to separate the lignin. The liquid component (X) can be obtained from the process described according to the first aspect, e.g. the liquid component (X) can be the same as the liquid component (L′) described herein. In some examples, the liquid component (X) is the liquid component (L′) obtained by the process described with reference to FIG. 1.

The alcohol (e.g. methanol) is fractionally distilled from the liquid component (X) and can be recycled and reused in the process. The liquid component (X) is fractioned into an aqueous component (Y) and an organic component (Z) comprising lignin. The ketone (e.g. MIBK) present in the organic component is then evaporated off, and lignin is separated.

### Example 3: Composite Material

A composite material can be prepared according to the process described in the first aspect e.g. the composite material can be the composite material obtained from the process described above with reference to FIG. 1.

In an example, a composite material obtained using the process disclosed in FIG. 1 comprises lignin and cellulose at a weight ratio of about 30:70 and an acid content of about 0.6 kg (in 12 kg dry solid, approximately 5% by dry mass). The composite material was pressed into a mould and placed in an oven at about 90° C. until dry (for approximately 4 hours). However, the precise temperature and amount of time required could be varied depending on e.g. the size of the mould, and amount of composite material required to dry. The resultant product obtained was a hard material which retained its shape when released from the mould.

### Example 4

In this Example, lignin was produced as shown and described above with reference to FIG. 3. The first sonication 10 was carried out on a slurry consisting essentially of biomass (wood), oxalic acid and water. Oxalic acid was present in the slurry at a concentration of 0.05 to 0.2 moles. The solids content of the slurry was 10 to 15 weight %. Sonication (25 kHz) was carried out at a temperature of 125 degrees C.

The second sonication 18 was carried out on a slurry comprising the solid separated by the filter 12. This solid was dispersed in a liquid medium comprising methanol and water. Methanol was present in this slurry at a concentration of 10 to 40 weight %. The solids content of this slurry was 10 to 15 weight %. Sonication (25 kHz) was carried out at a temperature of 115 degrees C.

Lignin was extracted by solvent extraction in solvent extraction units 24 and 26. The extracted lignin was analysed by GPC. The GPC chromatogram showed two distinct peaks with a retention time of 17.69 min and 18.62 min, corresponding to a number average molecular weight of 1156 g/mol and 321 g/mol respectively. The polydispersity index (PDI) of both peaks was close to 1.0 suggesting uniformity in the composition of the lignin sample. The molecular weights obtained were consistent with the molecular weights measured by Diffusion Ordered Spectroscopy (DOSy NMR).

The lignin produced in this Example was of a significantly lower molecular weight than lignin produced using organosolv reported in the literature (See Organosolv Lignin as a Green Sizing Agent for Thermoformed Pulp Products, ACS Omega 2022, 7, 46583-46593 (http://pubs.acs.org/journal/acsodf), where the reported lignin molecular weight is 3300 g/mol)).

What is claimed is:

1. A method of fractionating a biomass material, said method comprising:
dispersing biomass material in an aqueous medium comprising an acid to form a slurry, wherein the aqueous medium either does not comprise ketone or comprises ketone in an amount of less than 10 weight %;
sonicating the slurry to produce a sonicated mixture comprising a liquid component (L) comprising hemicellulose hydroxylates and a solid component (S) comprising lignin and cellulose,
wherein ratio of the weight of the lignin in the solid component (S) to the weight of the lignin in the liquid component (L) is greater than 2:1; and
wherein said method further comprises separating the lignin from the cellulose in the solid component.

2. The method according to claim 1, wherein the aqueous medium comprises oxalic acid.

3. The method according to claim 1, wherein the solid component (S) comprises at least 90% of lignin available from the biomass material, and/or the liquid component (L) comprises less than 10% of lignin available from the biomass material.

4. (canceled)

5. The method according to claim 1, wherein the biomass material is dispersed in an aqueous medium that comprises at least 80 weight % water.

6. The method according to claim 1, wherein lignin is separated from the solid component (S) by a process comprising solvent extraction.

7. The method according to claim 6, wherein lignin is separated from the solid component (S) by sonicating the solid component (S) in a liquid medium comprising alcohol and water to produce a further sonicated mixture comprising a liquid component comprising dissolved lignin and a solid component comprising cellulose, and extracting lignin from the liquid component of the further sonicated mixture.

8. The method according to claim 7, wherein the alcohol is methanol.

9. The method according to claim 7 wherein the alcohol is present in the liquid medium in an amount of 20 to 60 weight %, preferably 25 to 40 weight %, more preferably 30 to 35 weight %, and/or the liquid medium further comprises an acid, preferably oxalic acid.

10. (canceled)

11. The method according to claim 7, wherein lignin is extracted by solvent extraction using a water-immiscible organic solvent, preferably wherein the water-immiscible organic solvent comprises a ketone or an ester, more preferably wherein the ketone is methyl isobutyl ketone.

12. (canceled)

13. (canceled)

14. The method according to claim 7, which further comprises removing alcohol from the further sonicated mixture.

15. The method according to claim 14, wherein alcohol is removed after separating the solid component comprising cellulose from the further sonicated mixture and/or the dissolved lignin is extracted after removal of alcohol.

16. (canceled)

17. The method of fractionating a biomass material as claimed in claim 1, said method comprising
sonicating the solid component (S) comprising lignin and cellulose in a liquid medium comprising alcohol and at least 40 weight % water to produce a sonicated mixture comprising a liquid component comprising dissolved lignin and a solid component comprising cellulose, and
separating lignin from the liquid component of the sonicated mixture by solvent extraction using an organic solvent.

18. The method according to claim 17, wherein the alcohol is methanol.

19. The method according to claim 17, wherein the alcohol is present in the liquid medium in an amount of 20 to 60 weight %, preferably 25 to 40 weight %, more preferably 30 to 35 weight %.

20. The method according to claim 17, wherein the liquid medium further comprises an acid, preferably oxalic acid, and/or the liquid medium is free from methyl isobutyl ketone or comprises no more than 10 weight % methyl isobutyl ketone.

21. (canceled)

22. The method according to claim 17, wherein lignin is extracted by solvent extraction using a water-immiscible organic solvent, preferably wherein the water-immiscible organic solvent comprises a ketone or an ester, more preferably wherein the ketone is methyl isobutyl ketone.

23. (canceled)

24. (canceled)

25. The method according to claim 18, which further comprises removing alcohol from the further sonicated mixture, preferably wherein alcohol is removed after separating the solid component comprising cellulose from the further sonicated mixture, more preferably wherein the dissolved lignin is extracted after removal of alcohol.

26. (canceled)

27. (canceled)

28. The method according to claim 18, wherein the solid component (S) comprising lignin and cellulose is produced by dispersing biomass material in an aqueous medium to form a slurry, and sonicating the slurry to produce a sonicated mixture comprising a liquid component and the solid component (S) comprising lignin and cellulose, preferably wherein the aqueous medium used to form the slurry comprises at least 80 weight % water, and/or comprises alcohol, preferably, methanol and water.

29. (canceled)

30. The method according to claim 1, wherein the aqueous medium either does not comprise ketone or comprises ketone in an amount of less than 5 weight % or comprises ketone in an amount of less than 4 weight %.

31. (canceled)

32. The method according to claim 1, wherein where the aqueous medium contains alcohol and ketone, the combined amount of alcohol and ketone in the aqueous medium is less than 40 weight %.
